(19) United States
(12) Patent Application Publication
(10) Pub. No.: US 2018/0310248 A1
(43) Pub. Date: Oct. 25, 2018

(54) INFORMATION PROCESSING DEVICE, INFORMATION PROCESSING METHOD, AND PROGRAM

(71) Applicant: Sony Corporation, Tokyo (JP)

(72) Inventors: Daisuke Nakayama, Tokyo (JP); Masahiro Shimizu, Tokyo (JP); Yusuke Fujimoto, Kanagawa (JP); Masahiro Watanabe, Kanagawa (JP); Tetsunori Nakayama, Tokyo (JP)

(21) Appl. No.: 15/765,920

(22) PCT Filed: Nov. 11, 2016
(86) PCT No.: PCT/JP2016/083571

§ 371 Date: Apr. 4, 2018

(30) Foreign Application Priority Data
Dec. 22, 2015 (JP) 2015-249486

(51) Int. Cl. H04W 52/02; H04W 4/80

(52) U.S. Cl. CPC H04W 52/0235; H04W 4/80; H04W 52/0229

(57) ABSTRACT

An imaging system includes an imaging device; and an information processing device that receives a first communication from the imaging device, makes a condition determination, and, in a case where the imaging device satisfies a predetermined condition, sends a second communication to the imaging device, wherein the second communication includes at least a power ON request data.

### CROSS REFERENCE TO RELATED APPLICATIONS

This application claims the benefit of Japanese Priority Patent Application JP 2015-249486 filed Dec. 22, 2015, the entire contents of which are incorporated herein by reference.

### Technical Field

The present disclosure relates to an information processing device, an information processing method, and a program.

### Background Art

Products that apply the communication technology to imaging devices such as digital cameras have been gaining widespread use in recent years. The operation of such an imaging device can be controlled via communication from an external information processing device or the like.

For example, PTL 1 proposes the technology of controlling the operations of a plurality of imaging devices with a remote controller, and displaying an image acquired from each of the imaging devices on the display of the remote controller. The remote controller described in PTL 1 can also switch images without requesting any operation from a user.

### CITATION LIST

### Patent Literature

PTL 1: JP 2015-127920A

### SUMMARY

### Technical Problem

It is desired that the operation of connecting such a remote controller to an imaging device impose few loads on a user, and an easy operation is desired for such a connection. PTL 1 does not, however, mention anything about enhancing the usability for controlling the power of an imaging device that the remote controller remotely controls.

The present disclosure then proposes an information processing device, an information processing method, and a program that can automatically perform power ON control on an external device.

### Solution to Problem

According to an embodiment of the present disclosure, there is provided an imaging system including: an imaging device; and an information processing device configured to receive a first communication from the imaging device, to make a condition determination, and, in a case where the imaging device satisfies a predetermined condition, to send a second communication to the imaging device, wherein the second communication includes at least a power ON request data.

According to an embodiment of the present disclosure, there is provided a method of remotely communicating with an imaging device, comprising: receiving, by an information processing device, a first communication from the imaging device; making, by the information processing device, a condition determination; and in a case where the imaging device satisfies a predetermined condition, sending, by the information processing device, a second communication to the imaging device, wherein the second communication includes at least a power ON request data.

According to an embodiment of the present disclosure, there is provided a non-transitory computer-readable medium storing therein instructions that, when executed by a processor of an information processing device, cause the information processing device to perform operations comprising: receiving a first communication from the imaging device; making a condition determination; and in a case where the imaging device satisfies a predetermined condition, sending a second communication to the imaging device, wherein the second communication includes at least a power ON request data.

### Advantageous Effects of invention

According to embodiments of the present disclosure as described above, it is possible to automatically perform power ON control on an external device.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram for describing an overview of an information processing device according to an embodiment of the present disclosure.

FIG. 2 is a block diagram illustrating an example of a configuration of the information processing device according to the present embodiment,

FIG. 3 is a block diagram illustrating an example of a configuration of an imaging device according to the present embodiment.

FIG. 4 is a sequence diagram illustrating operation control processing of the information processing device and the imaging device according to the present embodiment.

FIG. 5 is a diagram for describing power OFF control according to the present embodiment.

FIG. 6 is a sequence diagram illustrating REC control processing according to the present embodiment.

### DESCRIPTION OF EMBODIMENTS

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

The description will be made in the following order.

1. Overview of information processing device according to embodiment of present disclosure

2. Configuration

2-1. Configuration of information processing device 10

2-2. Configuration of imaging device 20

3. Operation control examples

3-1. Operation control processing

3-2. Power OFF operation

3-3. REC operation

4. Conclusion

<<1. Overview of Information Processing Device According to Embodiment of Present Disclosure>>

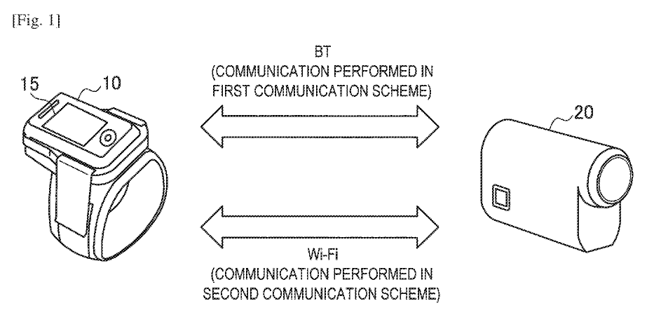

First of all, the overview of an information processing device according to an embodiment of the present disclosure will be described with reference to FIG. 1. An information processing device 10 illustrated in FIG. 1 establishes a communication connection to an imaging device 20, and functions as a remote controller that controls the operation of the imaging device 20. The information processing device 10 also displays a through image acquired from the imaging device 20 on a display unit 15 in real time to offer a so-called live view.

The information processing device 10 and the imaging device 20 each have a function of performing communication in different communication schemes. For example, the information processing device 10 can control communication performed in a first communication scheme and communication performed in a second communication scheme that is different from the first communication scheme. Specifically, for example, as illustrated in FIG. 1, examples of the communication performed in the first communication scheme include communication based on the IEEE 802.15 standard (which is also referred to as “Bluetooth” (registered trademark), and will be represented as “BT.”), while examples of the communication performed in the second communication scheme include communication based on the IEEE 80:2.11 standard (which will he represented as “Wi-Fi” (registered trademark).). The use of BT allows communication with less power. The information processing device 10 and the imaging device 20 may also use “Bluetooth low energy” (which will be represented as “BTLE”) as BT.

Wi-Fi carries the advantages that Wi-Fi is capable of more data communication than BT is because of greater bandwidth, and that some standards accept a band of 5 GHz for communication, and thus Wi-Fi is resistant to interference in countries and regions where the 2.4 GHz band is also used.

Meanwhile, BTLE carries the advantages that BTLE consumes less power than Wi-Fi does, and that BTLE hops communication frequencies to perform communication, and thus BTLE is resistant to radio jamming.

The different communication schemes according to the present embodiment are not limited to the two communication schemes of Wi-Fi and BT as illustrated in FIG. 1. Examples of the different communication schemes according to the present embodiment include two or more of Wi-Fi, BT, near field communication (NFC), optical wireless communication such as infrared communication, audio communication using sounds, wireless communication performed in any scheme such as long term evolution (LTE), and wired communication performed in any scheme such as a local area network (LAN).

It is assumed in the present embodiment that operating the information processing device 10 brings the imaging device 20 into operation (i.e. the information processing device 10 serves as a remote controller of the imaging device 20). The information processing device 10 transmits control information to the imaging device 20 to control the operation of the imaging device 20. Examples of the control information according to the present embodiment can include one or more of an imaging instruction, an instruction of causing the information processing device 10 to transmit a through image (that is being shot by the imaging unit of the imaging device 20, and is a so-called live view image), an instruction of causing the information processing device 10 to transmit data indicating the settings of the imaging device 20, and an instruction of changing the settings of the imaging device 20.

The information processing device 10 may be a wearable wristband terminal including a hand (example of attachment members) and a body (example of housings), for example, as illustrated in FIG. 1. This allows a user to wear the information processing device 10, for example, on the opposite arm to that of the dominant hand, and to operate a button and a switch (example of power operation members and imaging operation members) on the body with the dominant hand or to check a through image in real time (live view), the through image having been acquired from the imaging device 20 and being displayed on the display unit 15 on the body. The information processing device 10 is not limited to the wearable wristband terminal illustrated in FIG. 1, but may also be another wearable terminal (such as a wearable glasses-type terminal (eyewear) and a head mounted display (HMD)), a smartphone, a mobile phone terminal, a tablet terminal, or the like.

On the other hand, it is possible to control the operation of the imaging device 20 by operating the information processing device 10, allowing the imaging device 20 to be attached within a wider application range. For example, it is possible to make the imaging device 20 according to the present embodiment small, light, and strong (e.g. waterproof, dust-proof, shock-resistant, and low-temperature-resistant) in a manner that the imaging device 20 according to the present embodiment can be attached to a helmet or an instrument while a user is doing sports (such as cycling, finning, snow-boarding, skiing, driving, surfing, and diving), and the user can shoot an image of a scene making the user feel realistic during the sports with his or her hands free. Since the imaging device 20 applicable to sports is made small and light, and the display device is thus simplified or removed, it is assumed that an operation on the imaging device 20 such as controlling the imaging device 20 to capture an image or changing the settings of the imaging device 20 is performed by an external device such as the information processing device 10 serving as a remote controller. The housing of the imaging device 20 can be fixed by itself or by an external attachment not illustrated to a moving object such as a human and a vehicle, or another object such as an information processing terminal. The imaging device 20 may be implemented, for example, as a wearable camera that can be worn and used on the body of a user.

A button and a switch of the imaging device 20 are difficult for a user to operate at some attachment positions. It is desirable that power ON control on the imaging device 20 he automatically performed, or the communication connection of the imaging device 20 to the information processing device 10 be automatically established. According to the present embodiment, it is possible to automatically perform power ON control on the imaging device 20 and to automatically establish the communication connection of the imaging device 20 to the information processing device 10 in response to a user operation on the information processing device 10.

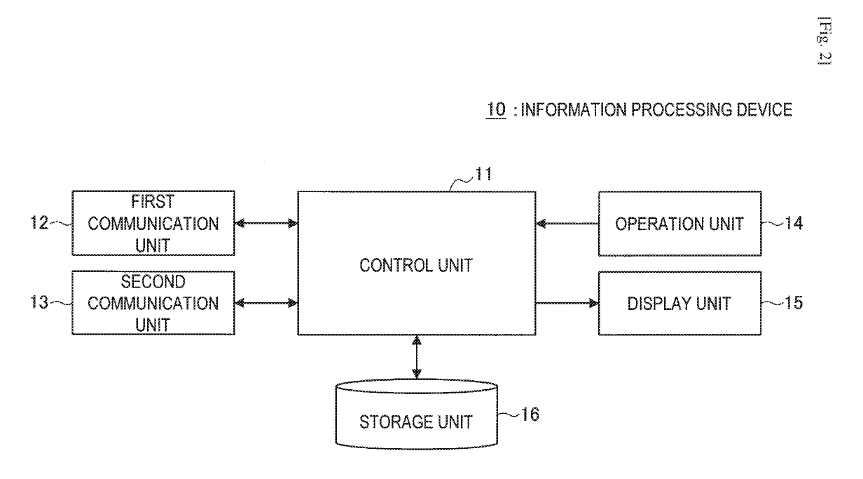

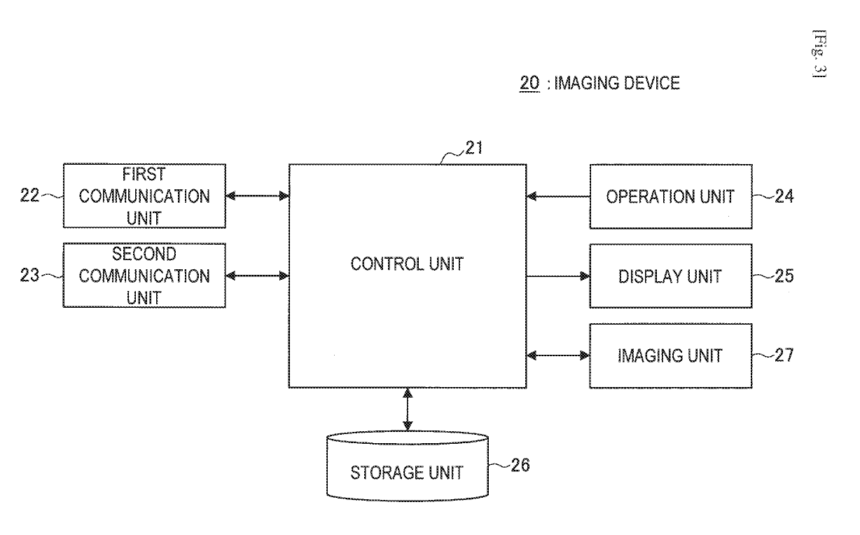

The overview of the information processing device 10 according to the present embodiment has been described so far. Next, the configurations of the information processing device 10 and the imaging device 20 according to the present embodiment will be described one by one with reference to FIGS. 2 and 3.

<<2. Configuration>>

<2-1. Configuration of Information Processing Device 10>FIG. 2 is a block diagram illustrating an example of the configuration of the information processing device 10 according to the present embodiment. As illustrated in FIG. 2, the information processing device 10 according to the present embodiment includes a control unit 11, a first communication unit 12, a second communication unit 13, an operation unit 14, a display unit 15, and a storage unit 16. For example, the body of the wearable terminal illustrated in FIG. 1 can include each unit illustrated in FIG. 2.

The control unit 11 functions as an operation processing device and a control device, and controls the overall operation of the information processing device 10 in accordance with a variety of programs. The control unit 11 is implemented as an electronic circuit such as a central processing unit (CPU) and a microprocessor. The control unit 11 may include a read only memory (ROM) that stores a program, an operation parameter and the like to he used, and a random access memory (RAM) that temporarily stores a parameter and the like varying as appropriate.

The control unit 11 according to the present embodiment detects a nearby external device (the imaging device 20 is used here as an example) through the first communication unit 12 in response to a power ON operation toward the information processing device 10, and performs control to transmit power ON request data to the detected external device. The control unit 11 can hereby perform control to automatically power on the external device. When transmitting the power ON request data, the control unit 11 may determine whether or not the external device has been authenticated. The control unit 11 determines whether or not the external device has been authenticated, for example, by a method of checking whether or not the external device has been paired with the information processing device 10. Specifically, the control unit 11 determines whether or not the detected external device has been paired with the information processing device 10 in advance, on the basis of device identification information. (e.g. identifier such as a Bluetooth device address) received from the external device, and performs control to transmit power ON request data to the external device from the information processing device 10 if the external device has been paired. It has been described here as an example of methods of determining whether or not the external device has been authenticated that it is determined whether or not the external device has been paired with the information processing device 10. However, the present embodiment is not limited thereto, but a predetermined method such as determining whether or not a connection history shows the identifier of a device may be used to determine whether or not the external device has been authenticated. The control unit 11 may also receive device state information from the authenticated external device, and makes a condition determination regarding whether to perform power ON control on the external device and to establish a wireless communication connection (such as a Wi-Fi connection) to the external device, on the basis of wireless communication connection mode information (such as connection mode information) and power state information included in the device state information.

The first communication unit 12 has a function of communicating with the imaging device 20 in the first communication scheme. The first communication unit 12 according to the present embodiment includes a BT communication port and a transmission and reception circuit (wireless communication) as an example. For example, the first communication unit 12 transmits power ON request data to the target imaging device 20 through BT communication.

The second communication unit 13 has a function of communicating with the imaging device 20 in a second communication scheme that is different from the first communication scheme. The second communication unit 13 according to the present embodiment includes a Wi-Fi communication port and a transmission and reception circuit (wireless communication) as an example. For example, the second communication unit 13 continuously receives through images from the imaging device 20 to which a Wi-Fi communication connection has been established, and transmits various kinds of control request data such as turning recording ON/OFF to the imaging device 20.

The operation unit 14 detects an operation input by a user, and outputs the detected operation input to the control unit 11. Examples of the operation unit 14 include a power ON/OFF button, a recording start/stop button, a switch, a direction key, and a rotary selector such as a jog dial.

The display unit 15 displays an operation screen, and a through image transmitted from the imaging device 20 under the control of the control unit 11. Examples of the display unit 15 include a liquid crystal display and an organic EL display.

The storage unit 16 is implemented as a flash memory or the like, and stores a program and a parameter for the control unit 11 to execute each function.

The configuration of the information processing device 10 according to the present embodiment has been described so far. The configuration illustrated in FIG. 2 is an example. The configuration of the information processing device 10 according to the present embodiment is not limited thereto.

<2-2. Configuration of Imaging Device 20>

Next, the configuration of the imaging device 20 according to the present embodiment will be described with reference to FIG. 3. FIG. 3 is a block diagram illustrating an example of the configuration of the imaging device 20 according to the present embodiment.

As illustrated in FIG. 3, the imaging device 20 according to the present embodiment includes a control unit 21, a first communication unit 22, a second communication unit 23, an operation unit 24, a display unit 25, an imaging unit 27, and a storage unit 26.

The control unit 21 functions as an operation processing device and a control device, and controls the overall operation of the imaging device 20 in accordance with a variety of programs. The control unit 21 is implemented as an electronic circuit such as a CPU and a microprocessor. The control unit 21 may include a ROM that stores a program, an operation parameter and the like to be used, and a RAM that temporarily stores a parameter and the like varying as appropriate.

When receiving power ON request data from the information processing device 10 through the first communication unit 22, the control unit 21 according to the present embodiment performs control to power on the imaging device 20. The possible power state of the imaging device 20 includes at least the following three:

Inactive state: the imaging device 20 is powered off, and at least the imaging unit 27 does not perform processing of capturing an image, or the first communication unit 22 and the second communication unit 23 do not either perform communication processing. However, some necessary circuits such as a clock circuit may be supplied with power. When the imaging device 20 is in the inactive state, a user can recognize that the imaging device 20 is powered off.

Standby state: at least some functions are not available such as processing performed by the imaging unit 27 to capture an image and communication processing through Wi-Fi communication (second communication unit 23). However, for example, a part of the system is supplied with power, and it is possible to transmit advertising packets through BT communication (first communication unit 22) and to receive power ON request data. When the imaging device 20 is in the standby state, a user can also recognize that the imaging device 20 is powered off.

Power ON state: it is possible to use more functions such as capturing an image by the imaging unit 27 and transmitting a through image through Wi-Fi communication than in the standby state. It is also possible to use both BT communication and Wi-Fi communication.

The first communication unit 22 has a function of communicating with the information processing device 10 in the first communication scheme. The first communication unit 22 according to the present embodiment includes a BT communication port and a transmission and reception circuit (wireless communication) as an example. For example, the first communication unit 22 regularly sends advertising packets around the first communication unit 22 through BT communication in the standby state. The advertising packets are beacon signals that notify a nearby device of the presence of the imaging device 20 when the imaging device 20 is in the standby state. Examples of the advertising packets include the device identifier (example of device identification information), the name, the function, and service information of the imaging device 20.

The second communication unit 23 has a function of communicating with the information processing device 10 in a second communication scheme that is different from the first communication scheme. The second communication unit 23 according to the present embodiment includes a communication port and a transmission and reception circuit (wireless communication) as an example. For example, in the power ON state, the second communication unit 23 continuously transmits captured images acquired through the imaging unit 27 as through images to the information processing device 10 to which a Wi-Fi communication connection has been established.

The operation unit 24 detects an operation input by a user, and outputs the detected operation input to the control unit 21. Examples of the operation unit 24 include the power ON/OFF button, the recording start/stop button, and a switch of the imaging device 20.

The display unit 25 displays a screen or the like indicating state information such as the power state, the communication state, or the remaining battery of the imaging device 20. Examples of the display unit 25 include a liquid crystal display and an organic EL display.

The storage unit 26 is implemented as a flash memory or the like, and stores a program and a parameter for the control unit 21 to execute each function.

The imaging unit 27 has a function of generating an image (moving or still image) by capturing the image. The imaging unit 27 includes, for example, a lens/imaging element and a signal processing circuit. The lens/imaging element is implemented, for example, as an optical lens, and an image sensor including a plurality of imaging elements such as complementary metal oxide semiconductors (CMOSs). The signal processing circuit includes, for example, an AGC circuit and an ADC, and converts analog signals generated by the imaging elements into digital signals (image data). In addition, the signal processing circuit performs various kinds of processing, for example, for RAW development. Furthermore, the signal processing circuit may perform various kinds of signal processing such as white balance correction, color correction, gamma correction, YCbCr conversion, and edge enhancement,

The configuration of the imaging device 20 according to the present embodiment has been specifically described so far. The configuration illustrated in FIG. 3 is an example. The configuration of the imaging device 20 according to the present embodiment is not limited thereto.

<<3. Operation Control Examples>>

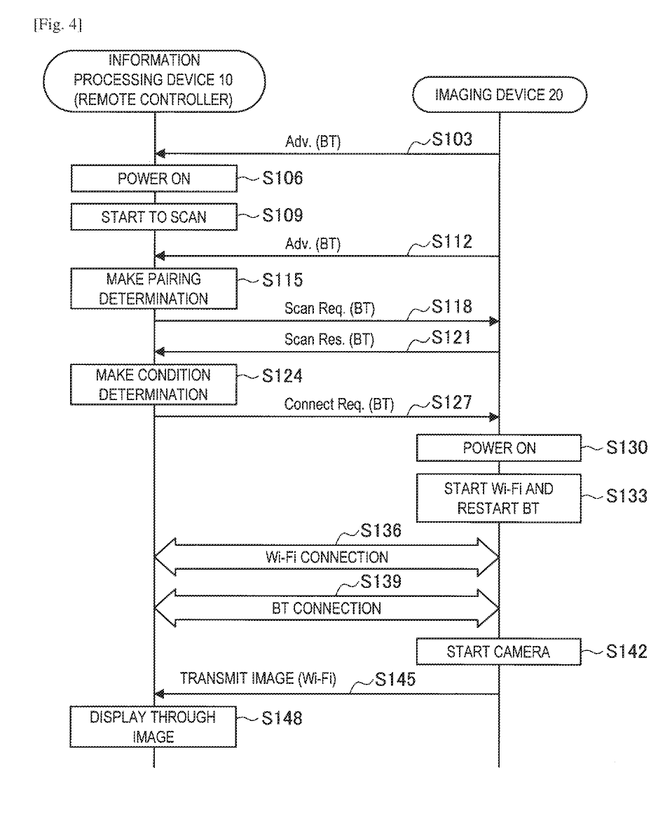

Next, operation control on the information processing device 10 and the imaging device 20 according to the present embodiment will be described with reference to FIGS. 4 to 6. The information processing device 10 according to the present embodiment is capable of a single mode connection for establishing a one-to-one communication connection to the imaging device 20 to remotely control the operation of the one imaging device 20, and a multi-mode connection for establishing a many-to-one connection to the plurality of imaging devices 20 to remotely control the operations of the plurality of imaging devices 20, Operation control in connecting to the one imaging device 20 in the single mode will be described here as an example.

<3-1. Operation Control Processing>

As discussed above, the imaging device 20 according to the present embodiment is made small, light, and strong, and attached to a helmet or an instrument, for example, while a user is playing sports, so that the user can shoot an image of a scene making the user feel realistic during the sports with his or her hands free. In this case, some attachment positions make it difficult for the user to operate a button or a switch. The present embodiment thus makes it possible to enhance the usability of the imaging device 20 by performing power ON control on the imaging device 20, and performing control to automatically establish a communication connection between the information processing device 10 and the imaging device 20 in response to a user's power ON operation on the information processing device 10.

FIG. 4 is a sequence diagram illustrating operation control processing of a system including the information processing device 10 and the imaging device 20 according to the present embodiment. For example, the control unit 11 of the information processing device 10 and the control unit 21 of the imaging device 20 perform control, thereby performing the operation control processing illustrated in FIG. 4.

As illustrated in FIG. 4, first of all, the imaging device 2.0 continuously sends advertising packets (beacons) through BT communication in the standby state (step S103).

Next, when a user performs a power ON operation (specifically, pushes down the power switch) to power on the information processing device 10 (step S106), the information processing device 10 starts to detect (which will also be referred to as scan) the nearby imaging device 20 (step S109).

Next, when receiving the advertising packets continuously sent from the imaging device 20 (step S112), the information processing device 10 determines whether or not the imaging device 20 has been paired with the information processing device 10 (step S115). Specifically, the information processing device 10 determines whether or not the imaging device 20 has been authenticated, on the basis of the identifier of the imaging device 20 (e.g. Bluetooth device address) included in the advertising packets sent from the imaging device 20. In the pairing processing performed in advance, the Bluetooth device address and the encryption key of the imaging device 20 are transmitted from the imaging device 20 to the information processing device 10, and stored in the information processing device 10.

Next, the information processing device 10 transmits a scan request through BT communication to the imaging device 20 determined to have been paired with the information processing device 10 as a result of the pairing determination (step SI18).

When receiving a scan response from the imaging device 20 through BT communication (step S121), the information processing device 10 then makes a condition determination (step S124). The scan response includes the Wi-Fi connection mode information and the power state information on the imaging device 20. The information processing device 10 checks the Wi-Fi connection mode (single mode or multi-mode) and the power state, and determines whether or not the imaging device 20 satisfies predetermined conditions for transmitting a connection request. As an example, the predetermined conditions mean that, for example, the Wi-Fi connection mode of the imaging device 20 agrees with the Wi-Fi connection mode of the information processing device 10, and that the power state of the imaging device 20 is the standby state (waiting for a power ON instruction). The single mode and the multi-mode of the Wi-Fi connection mode will be here described. In the single mode, the imaging device 20 and the information processing device 10 respectively function as an access point (master device) and a station (slave device), and the imaging device 20 has a one-to-one connection to the information processing device 10. Additionally or alternatively, the predetermined conditions may mean that, for example, the imaging device 20 and the information processing device 10 have been recently connected (i.e. within a given period of time); the imaging device 20 and the information processing device 10 have a connection history; the imaging device 20 and the information processing device 10 have correct authentication information; and the like. Meanwhile, in the multi-mode, the imaging device 20 and the information processing device 10 respectively function as a station (slave device) and an access point (master device), and the imaging device 20 has a many-to-one connection to the information processing device 10.

Next, the information processing device 10 transmits a connection request to imaging device 20 that satisfies the conditions (step S127).

When receiving the connection request from the information processing device 10, the imaging device 20 is then powered on in accordance with the connection request (step S130), starts Wi-Fi, and restarts BT (step S133). It is also possible to keep BT on without restarting BT.

The imaging device 20 then establishes a Wi-Fi connection (step S136) and a BT connection (step S139) to the information processing device 10.

The imaging device 20 also starts the camera (imaging unit 27) of the imaging device 20 (step S142), and transmits a captured image acquired through the imaging unit 27 to the information processing device 10 through Wi-Fi communication as a through image (step S145).

The information processing device 10 then displays a through image transmitted from the imaging device 20 on the display unit 15 in real time to offer a live view (step S148).

Additionally, the above-described series of operations of starting Wi-Fi, BT and the camera, and transmitting a through image after the imaging device 20 is powered on may be set in the imaging device 20 in advance in a manner that the series of operations are performed after the imaging device 20 is powered on.

As described above, the information processing device 10 according to the present embodiment automatically detects the imaging device 20 and performs control to power on the imaging device 20 when a power ON operation is performed. The imaging device 20 subjected to the power ON control establishes a communication connection to the information processing device 10, starts the camera, transmits a through image captured by the camera to the information processing device 10 in real time, and starts a live view. This allows a user to perform power ON control on the imaging device 20 just by powering on the information processing device 10 without being requested to select the imaging device 20 or to perform any power ON instruction operation even when the imaging device 20 is installed in a place where the imaging device 20 is difficult to operate.

Although the above-described embodiment describes the one-to-one operation processing for the Wi-Fi connection mode set as the single mode, the present embodiment is not limited thereto. The many-to-one operation processing for the multi-mode may be similarly performed. In other words, when powered on through a power ON operation by a user, the information processing device 10 set in the multi-mode starts to detect the imaging device 20, makes a pairing determination and a condition determination for the detected imaging device 20, and performs power ON control on the imaging device 20 that satisfies the conditions. The information processing device 10 continues scanning until the number of imaging devices 20 to which Wi-Fi connections are established reaches the predetermined maximum number of connections (which can be set by a user), and can then establish communication connections to the plurality of imaging devices 20. Through images acquired from the plurality of imaging devices 20 may be listed on the display unit 15 of the information processing device 10, or one selected through image may be displayed along with the selection icons of the plurality of through images.

The imaging device 20 according to the present embodiment can also be controlled to send no advertising packets in spite of the standby state when the BT remote control power settings of the imaging device 20 are off (i.e. the imaging device 20 is set not to be remotely powered on). Meanwhile, the imaging device 20 according to the present embodiment may be controlled to send no advertising packets with no external devices registered (i.e. no external devices are paired), even when the BT remote control power settings of the imaging device 20 are on (i.e. the imaging device 20 is set to he remotely powered on).

<3-2. Power OFF Operation>

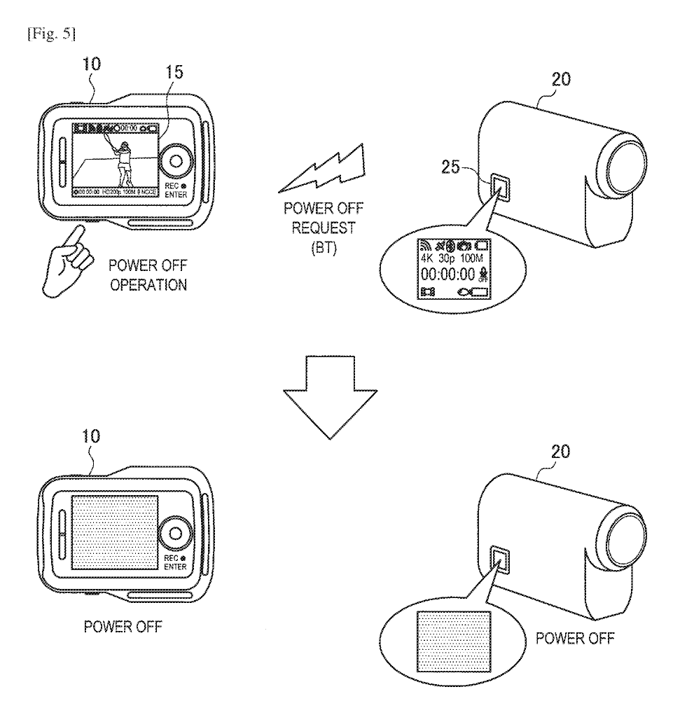

The information processing device 10 according to the present embodiment can also perform power OFF control on the imaging device 20 as an example of basic remote operations. FIG. 5 is a diagram for describing power OFF control according to the present embodiment. For example, if a user performs a power OFF operation (such as pushing down the power button) as illustrated in the top of FIG. 5 while the information processing device 10 has a Wi-Fi communication connection and BT communication connection to the imaging device 20 and is displaying through images received from the imaging device 20 on the display unit 15 to offer a live view, the information processing device 10 transmits power OFF request data to the imaging device 20 through BT communication (such as BTLE communication). If the imaging device 20 is provided with the display unit 25, the display unit 25 displays various kinds of information such as time, radio state, power state, remaining battery, and communication state as illustrated in FIG. 5.

As illustrated in the bottom of FIG. 5, the information processing device 10 is then powered off, and the imaging device 20 is also powered off in accordance with the power OFF request data from the information processing device 10.

In this way, a user just performs a power OFF operation on the information processing device 10, thereby automatically performing power OFF control on the connected imaging device 20.

(Other power OFF behavior)

Although it has been described in the above-described embodiment that the connected imaging device 20 is automatically powered off in association with a power OFF operation on the information processing device 10, the present embodiment is not limited thereto. For example, when the information processing device 10 is forced to be powered off irrespective of a user's intention because the battery has run out or the temperature increases, it is also possible to keep the imaging device 20 powered on without transmitting power OFF request data to the imaging device 20.

When the connected imaging device 20 is powered off due to a user's operation or the like, the information processing device 10 remains powered on. In other words, the side of the information processing device 10 (central device) alone may serve as a remote power association trigger.

<3-3. ITEC Operation>

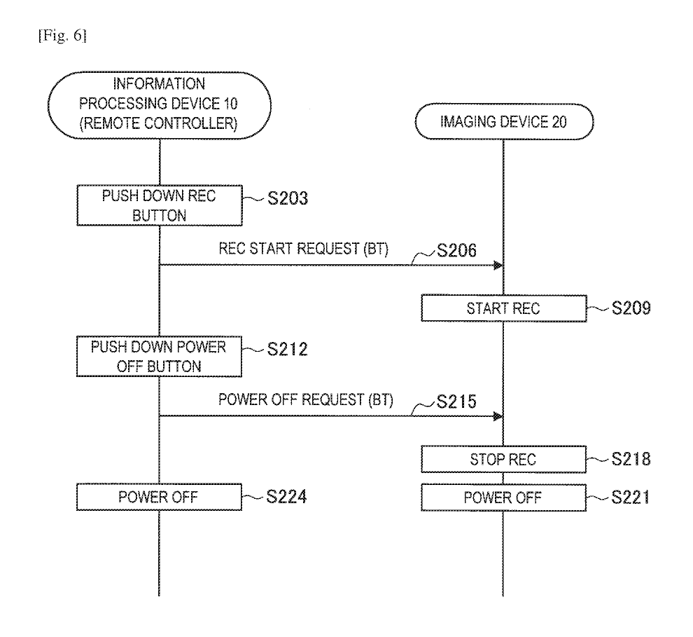

Next, a remote RCC operation according to the present embodiment will be described as another example of the basic remote operations with reference to FIG. 6. FIG. 6 is a sequence diagram illustrating REC control processing according to the present embodiment.

First of all, it is presupposed that the information processing device 10 and the imaging device 20 have been powered on, and established a Wi-Fi communication connection and a BT communication connection. When a user pushes down the REC button in this case (step S203), the information processing device 10 transmits REC start request data to the imaging device 20 through BT communication (step S206).

Next, the imaging device 20 starts recording in accordance with the REC start request data transmitted from the information processing device 10 (step S209),

When the power OFF button of the information processing device 10 is pushed down by the user (step S212), the information processing device 10 then transmits power OFF request data to the imaging device 20 through BT communication (step S215).

Next, the imaging device 20 stops recording (step S218), and is powered off (step S221) in accordance with the power OFF request data received from the information processing device 10.

On the other hand, the information processing device 10 is also powered off in accordance with the power OFF button being pushed down as discussed above (step S224).

<4. Conclusion>>

As discussed above, the information processing device 10 according to an embodiment of the present disclosure can automatically power on an external device (such as the imaging device 20) in response to a user's power ON operation.

It should be understood by those skilled in the art that various modifications, combinations, sub-combinations and alterations may occur depending on design requirements and other factors insofar as they are within the scope of the appended claims or the equivalents thereof.

It is also possible to create a computer program for causing the hardware such as the CPU, the ROM, and the RAM built in the above-described information processing device 10 and imaging device 20 to perform the functions of the information processing device 10 and the imaging device 20. There is also provided a computer readable storage medium having the computer program stored therein.

Further, the effects described in this specification are merely illustrative or exemplified effects, and are not limitative. That is, with or in the place of the above effects, the technology according to the present disclosure may achieve other effects that are clear to those skilled in the art based on the description of this specification.

Additionally, the present technology may also he configured as below.

(1) An imaging system including: an imaging device; and an information processing device configured to receive a first communication from the imaging device, to make a condition determination, and, in a case where the imaging device satisfies a predetermined condition, to send a second communication to the imaging device, wherein the second communication includes at least a power ON request data.

(2) The imaging system according to (1), wherein the first communication is a scan response.

(3) The imaging system according to (1) or (2), wherein the second communication is a connection request.

(4) An information processing device configured to: receive a first communication from an imaging device; make a condition determination; and in a case where the imaging device satisfies a predetermined condition, to send a second communication to the imaging device, wherein the second communication includes at least a power ON request data.

(5) The information processing device according to (4), wherein the information processing device is configured to receive advertising packets from the imaging device.

(6) The information processing device according to (5), wherein the information processing device is configured to determine whether the imaging device has been paired with the information processing device, upon receiving the advertising packets continuously sent from the imaging device.

(7) The information processing device according to (6), wherein, in a case where the information processing device determines that the imaging device has been paired with the information processing device, the information processing device is configured to transmit a scan request to the imaging device.

(8) The information processing device according to any one of (4) to (7), wherein the imaging device is one of a plurality of imaging devices, and the information processing device is configured to perform a scanning until connections to a predetermined number of the plurality of imaging devices have been established.

(9) The information processing device according to (8), wherein the predetermined number is set by a user.

(10) The information processing device according to any one of (4) to (9), wherein the first communication is a scan response.

(11) The information processing device according to any one of (4) to (10), wherein the second communication is a connection request.

(12) The information processing device according to any one of (4) to (11), wherein the predetermined condition corresponds to whether the imaging device and the information processing device have a predetermined master-slave relationship.

(13) The information processing device according to any one of (4) to (12), wherein the predetermined condition corresponds to whether the imaging device and the information processing device have been recently connected within a predetermined amount of time.

(14) The information processing device according to any one of (4) to (13), wherein the predetermined condition corresponds to whether the imaging device and the information processing device have a predetermined connection history.

(15) The information processing device according to any one of (4) to (14), wherein the imaging device and the information processing device are respectively configured to perform communication in a plurality of communication schemes.

(16) The information processing device according to (15) wherein the plurality of communication schemes includes two or more selected from: a Bluetooth standard, a Wi-Fi standard, a near field communication standard, an optical wireless communication scheme, an audio communication scheme, a wireless communication scheme, and a wired communication scheme.

(17) The information processing device according to any one of (4) to (16), wherein the information processing device includes a control unit, a communication unit, and a display.

(18) The information processing device according to any one of (4) to (17), wherein the imaging device is a wearable wristband terminal.

(19) A method of remotely communicating with an imaging device, comprising: receiving, by an information processing device, a first communication from the imaging device; making, by the information processing device, a condition determination; and in a case where the imaging device satisfies a predetermined condition, sending, by the information processing device, a second communication to the imaging device, wherein the second communication includes at least a power ON request data.

(20) A non-transitory computer-readable medium storing therein instructions that, when executed by a processor of an information processing device, cause the information processing device to perform operations comprising: receiving a first communication from the imaging device; making a condition determination; and in a case where the imaging device satisfies a predetermined condition, sending a second communication to the imaging device, wherein the second communication includes at least a power ON request data.

(21) An information processing device including:

a control unit configured to automatically start detection processing of an external device in a wireless communication scheme in response to detecting that a user has performed a power ON operation on the information processing device, to perform determination processing of determining whether or not the external device detected by the detection processing is an authenticated external device, on the basis of device identification information received from the detected external device, and to perform control to transmit, to the external device, power ON request data that requests the external device to be powered on, in accordance with a result of the determination processing.

(22) The information processing device according to (21), wherein the device identification information is a device address of the external device.

(23) The information processing device according to (21) or (22), wherein the control unit performs condition determination processing on the basis of device state information received from the authenticated external device, and performs control to transmit the power ON request data to the external device that satisfies a condition.

(24) The information processing device according to (23), wherein the control unit determines whether or not a connection mode of the external device agrees with a connection mode of the information processing device, on the basis of wireless communication connection mode information included in the device state information, and performs control to transmit the power ON request data to the external device when the connection mode of the external device agrees with the connection mode of the information processing device.

(25) The information processing device according to (23) or (24), wherein the control unit determines a power state of the external device, on the basis of power state information included in the device state information, and performs control to transmit the power ON request data to the external device when the external device is in a state of waiting for a power ON instruction.

(26) The information processing device according to any one of (21) to (25), wherein the control unit performs processing of establishing communication with the external device in a power ON state in another wireless communication scheme that is different from the wireless communication scheme.

(27) The information processing device according to (26), wherein the control unit performs the detection processing of the external device on the, basis of the device identification information on the external device, the device identification information being transmitted when the external device is in a state of not performing wireless communication in the other wireless communication scheme, but transmitting the device identification information on the external device in the wireless communication scheme at a predetermined interval.

(28) The information processing device according to (27), wherein when the information processing device is connectable to a plurality of external devices, the control unit transmits the power ON request data to the external device in accordance with the result of the determination processing until a number of communication connections established in the other wireless communication scheme reaches a predetermined number of connections, the power ON request data requesting the external device to be powered on.

(29) The information processing device according to (28), wherein the wireless communication scheme is Bluetooth (registered trademark), and the other wireless communication scheme that is different from the wireless communication scheme is Wi-Fi (registered trademark).

(30) The information processing device according to any one of (21) to (29), wherein the external device is an imaging device, and

the information processing device is a remote controller that operates the imaging device.

(31) The information processing device according to (30), further including:

a housing configured to be worn by the user via an attachment member;

a power operation member on the housing, the power operation member corresponding to the power ON operation; and

an imaging operation member on the housing, the imaging operation member corresponding to an imaging operation of the imaging device.

(32) The information processing device according to (30) or (31), further including:

a display configured to display, in real time, a captured image received from the imaging device.

(33) An information processing method including:

by a processor, automatically starting detection processing of an external device in a wireless communication scheme in response to detecting that a user has performed a power ON operation on the information processing device, performing determination processing of determining whether or not the external device detected by the detection processing is an authenticated external device, on the basis of device identification information received from the detected external device, and performing control to transmit, to the external device, power ON request data that requests the external device to be powered on, in accordance with a result of the determination processing.

(34) A program for causing a computer to function as:

a control unit configured to automatically start detection processing of an external device in a wireless communication scheme in response to detecting that a user has performed a power ON operation on the information processing device, to perform determination processing of determining whether or not the external device detected by the detection processing is an authenticated external device, on the basis of device identification information received from the detected external device, and to perform control to transmit, to the external device, power ON request data that requests the external device to be powered on, in accordance with a result of the determination processing.

### REFERENCE SIGNS LIST

10 information processing device

11 control unit

12 first communication unit

13 second communication unit

14 operation unit

15 display unit

16 storage unit

20 imaging device

21 control unit

22 first communication unit

23 second communication unit

24 operation unit

25 display unit

26 storage unit

27 imaging unit

1. An imaging system including:
an imaging device; and
an information processing device configured to receive a first communication from the imaging device, to make a condition determination,
and, in a case where the imaging device satisfies a predetermined condition, to send a second communication to the imaging device,
wherein the second communication includes at least a power ON request data.

2. The imaging system according to claim 1, wherein the first communication is a scan response.

3. The imaging system according to claim 1, wherein the second communication includes a connection request.

4. An information processing device configured to:
receive a first communication from an imaging device;
make a condition determination; and
in a case where the imaging device satisfies a predetermined condition, to send a second communication to the imaging device,
wherein the second communication includes at least a power ON request data,

5. The information processing device according to claim 4, wherein the information processing device is configured to receive advertising packets from the imaging device.

6. The information processing device according to claim 5, wherein the information processing device is configured to determine whether the imaging device has been paired with the information processing device, upon receiving the advertising packets continuously sent from the imaging device.

7. The information processing device according to claim 6, wherein, in a case where the information processing device determines that the imaging device has been paired with the information processing device, the information processing device is configured to transmit a scan request to the imaging device.

8. The information processing device according to claim 4, wherein the imaging device is one of a plurality of imaging devices, and the information processing device is configured to perform a scanning until connections to a predetermined number of the plurality of imaging devices have been established.

9. The information processing device according to claim 8, wherein the predetermined number is set by a user.

10. The information processing device according to claim 4, wherein the first communication is a scan response.

11. The information processing device according to claim 4, wherein the second communication includes a connection request.

12. The information processing device according to claim 4, wherein the predetermined condition corresponds to whether the imaging device and the information processing device have a predetermined master-slave relationship.

13. The information processing device according to claim 4, wherein the predetermined condition corresponds to whether the imaging device and the information processing device have been recently connected within a predetermined amount of time.

14. The information processing device according to claim 4, wherein the predetermined condition corresponds to whether the imaging device and the information processing device have a predetermined connection history.

15. The information processing device according to claim 4, wherein the imaging device and the information processing device are respectively configured to perform communication in a plurality of communication schemes.

16. The information processing device according to claim 15, wherein the plurality of communication schemes includes two or more selected from: a Bluetooth standard, a Wi-Fi standard, a near field communication standard, an optical wireless communication scheme, an audio communication scheme, a wireless communication scheme, and a wired communication scheme.

17. The information processing device according to claim 4, wherein the information processing device includes a control unit, a communication unit, and a display.

18. The information processing device according to claim 4, wherein the imaging device is a wearable wristband terminal.

19. A method of remotely communicating with an imaging device, comprising:
receiving, by an information processing device, a first communication from the imaging device;
making, by the information processing device, a condition determination; and
in a case where the imaging device satisfies a predetermined condition, sending, by the information processing device, a second communication to the imaging device,
wherein the second communication includes at least a power ON request data.

20. A non-transitory computer-readable medium storing therein instructions that, when executed by a processor of an information processing device, cause the information processing device to perform operations comprising:
receiving a first communication from the imaging device;
making a condition determination; and
in a case where the imaging device satisfies a predetermined condition, sending a second communication to the imaging device,
wherein the second communication includes at least a power ON request data.
